(19) United States
(12) Patent Application Publication
(10) Pub. No.: US 2008/0272250 A1
(43) Pub. Date: Nov. 6, 2008

(54) GLIDING WRIST AND FOREARM SUPPORT FOR MOUSE USERS

(76) Inventors: Sun Ki Oh, Lansdale, PA (US); Byung Han Kim, Zhangjiagang City (CN)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 11/860,706

(22) Filed: Sep. 25, 2007

(30) Foreign Application Priority Data
May 6, 2007 (CN) 200720039756.2
Jun. 6, 2007 (CN) 200710023340.6

(51) Int. Cl. B43L 15/00

(52) U.S. Cl. 248/118.5; 248/918

(57) ABSTRACT

A wrist supporting chassis is mounted on independent swiveling rollers for carrying the wrist of a user of a pointing device such as a computer mouse on a desktop or other surface. The swiveling rollers are carried on swivel arms in recesses on an underside of the chassis, arranged to rotate freely on a vertical axis, perpendicular to the desktop or surface. The swivel arms define a radius from the swivel axis to a roller carried on an axle parallel to the desktop and perpendicular to both the radius and the swivel axis. The swivel arm is mounted to the chassis by a hub that fits into a collar with an intervening bushing or ball bearing. In exemplary embodiments, the swivel arm can be a disc with a central hub, the roller axle being heat-pressed into the disc to occupy a radial slot at the outer edge of the disc. Alternatively, a spring biased arrangement for the roller axle can be provided on facing channels the define a range of roller displacement.

### BACKGROUND

1. Field of the Invention

The invention pertains to a support for movably carrying a user's wrist and forearm in a manner that facilitates manual positioning of a computer mouse or similar pointing device at a desired location on a surface, especially for controlling the position of a cursor on an associated computer or gaming display.

2. Related Art

Pointing devices are convenient input devices for use when operating a computer or similar device or terminal. Among other uses, pointing devices are employed to move a cursor to a desired position on a display field, often before operating a switch to achieve some function associated with the cursor position. Among other functions, pointing devices can selectively invoke URL links on a web page, indicate a selection offered on a menu, highlight, drag and drop icons, control gaming avatars, etc. One of the most popular pointing devices is the so-called mouse.

A computer mouse can be coupled by wire or wireless to a mouse controller. The mouse is designed to produce pulses as a function of displacement of the mouse over a surface, in mutually perpendicular directions. The mouse typically has at least one associated switch, some designs having two switches (“left-click” and “right-click”) plus a roller. These devices are used for various functions according to programming of the processor to which the mouse is coupled. However some standard functions have become common, such as selecting an icon by hovering the cursor over the icon, opening a menu with right-click, making a selection with left-click, scrolling using the rollers, etc.

The input device that senses the mouse position can be mechanical, e.g., having a ball that rolls against shaft rotation sensors oriented on perpendicular axes. The ball has a rubber or elastomer surface to obtain positive rolling action on a flat surface. Usually the surface is a desktop or auxiliary panel adjacent to a keyboard. The mouse can be used on a bare desktop. Often the surface a mouse pad is used to present a surface over which the mouse slides easily. The mouse pad may be faced with a fabric or polymer surface that provides friction with the surface of the mouse ball, for positive cursor positioning control because the mouse ball does not slip on the faced pad to the extent that the ball might slip on a bare desktop.

An alternative type of mouse uses light signals emitted from the mouse to sense relative displacement of the mouse over the underlying surface. The positioning control afforded with this so-called optical type of mouse does not depend on the nature of contact with the underlying surface. However the mouse is used in the same way as a roller ball mouse, namely by sliding the mouse over a two dimensional area to control a program that positions a cursor on a display. Typically, the cursor is displaced on a two dimensional display area by approximately the same distance and direction as the relative displacement of the mouse from a starting point on a two dimensional desktop or mouse pad.

The typical mouse has a rounded over shape that fits under the user's hand against the palm, with the front end of the mouse, namely the end having the right and left click buttons, extending beyond the palm to place the switches under the index and middle finger. The thumb rests on one lateral side of the mouse and the ring and little fingers rest against the opposite side.

The operations that one typically undertakes with a personal or business computer involve frequent instances where the mouse is used for pointing and clicking, etc. At times, mouse pointing is interspersed with typing. At other times, the mouse is used as the primary input device. The mouse is usually placed at a distance from the front edge of a desktop. The user rests his or her forearm on the desktop, extending beyond the front edge. The hand rests on the mouse. The mouse is moved from its starting position by a combination of actions including moving the mouse with the fingers relative to a substantially stationary palm, bending side-to-side at the wrist, sliding the forearm longitudinally and laterally over the desktop, and occasionally lifting the mouse up from the surface to begin at a new starting position that is more conveniently located.

A mouse is not heavy, but concentrated use of a mouse for long periods of time can become uncomfortable. Sliding the forearm relative to the desktop or sliding the wrist over the desktop while manipulating the mouse can be mildly abrasive. The wrist may become tired after maintaining a particular position for the hand and mouse for a long time. There are certain users with wrist or arm disabilities such as carpal tunnel syndrome, or other challenges to mobility, for whom controlling a mouse entails added effort or discomfort.

To assist such people, it is known to provide a mouse pad with a raised pad at the front, where the user rests his/her wrist. A raised pad is useful for support but it is also a point for abrasion with the wrist. U.S. Pat. No. 6,547,193—Money et al. discloses a raised structure at the user-side of a mouse pad, carrying several roller balls in a trough. The user's wrist is to ride on the roller balls, being movable forward, backward and/or laterally while carried on the roller balls in the trough.

An alternative is to provide a wrist support that carries the user's wrist and is movable relative to the desktop while supporting the user's wrist and forearm. KR 20-0313330 discloses a small cushioned carriage supported by three roller balls on the underside. The carriage has spring mounted clamping jaws at the front, that grasp the lateral sides of a mouse. In this way, the wrist supporting cushion is rigidly affixed to the mouse and moves with the mouse. A drawback of this arrangement is that the mouse cannot move independently, e.g., by finger manipulation while the user's hand is more or less stationary. In order to move the mouse, one must move also the attached cushioned carriage due to their attachment.

KR 20-0223993 discloses a cushioned carriage supported by ball bearings (roller balls) or by wheels, wherein the carriage is not affixed to the mouse. The user rests his wrist on a cushioned carriage that can have a raised hump shape or a depressed valley for receiving the wrist. The mouse is held in front of the carriage, resting under the user's palm and held by the user's fingers. The wheels or roller balls are located at the corners of the carriage. As the user moves the carriage over the desktop or other surface under the wrist, the mouse also moves, and there is some potential for movement of the mouse relative to the wrist by finger manipulation.

Wrist supporting carriages as described have not been widely accepted. The carriage provides support and is movable, but not as freely as might be desired. Insofar as the carriage is not fully free to move in different directions, using the carriage can be annoying, perhaps less desirable than having no support at all. In the case of ball bearing roller balls, the balls have no defined rotation axis. Although this might be considered desirable to permit rolling in any direction, the lack of a rolling axis results in a roller ball mounting that is characterized by friction when moving in any direction. The balls have a tendency to slide relative to the desktop rather than to roll, especially when using metal roller balls on a smooth desktop.

If wheels or rollers are mounted to carry the carriage, the wheels can be carried on axles with very little friction. However, the wheels are freely movable only in their rolling direction, perpendicular to the rotation axis defined by their axles. KR 20-0223993 discloses an embodiment having wheels but lacks an adequate arrangement to cause the wheels to steer in the direction of movement needed. The wheels tend to slide rather than to roll.

The necessary motions include translation in a line over the desktop, forward and back, laterally or diagonally. One could align a set of wheels on a wrist support so that they roll in one such direction, but only by also restricting freedom of movement in other directions. In fact, if the wheels are aligned to aim in unison in any direction for movement in translation, the individual wheels on the carriage will be misaligned for movements involving turning of the carriage (rotation around an axis normal to the desktop). The wheels slide rather than roll.

What is needed is a support that comfortably supports the wrist, preferably at a very low elevation relative to the desktop, wherein the support is carried on low friction rollers that are driven by the manual motion of the user's wrist alone, to realign independently, and to roll with low friction in any chosen direction. What is needed is a low elevation supporting roller structure capable of changing directions constantly and randomly during the normal pointing operations of a mouse, arranged to reduce the extent to which the rollers or wheels can slide relative to the desktop.

### SUMMARY

An object of the present invention is to provide a comfortable wrist supporting rolling carriage or pad for a mouse user, which carriage or pad has supports capable of repeatedly changing movement directions, in an easy and relaxed manner without sliding, such directions including translation in any direction over a desktop and also including rotation of the carriage wherein different supporting wheels actually align and roll in diverse directions.

To accomplish the above object, a wrist supporting mouse pad is provided with a chassis having at least three spaced supports, each forming a wide caster arrangement. The supports each comprise low-friction swivel frames shaped as rotatable discs mounted on central bushings or bearings so as to rotate freely on swivel axes that are perpendicular (normal) to the plane of the desktop or other support surface. The supports are distributed over the area of the carriage under the wrist, for example in a triangular or preferably rectangular array.

Each swivel frame carries a roller placed eccentrically to the swivel axis. The roller is mounted to rotate on a roller axle defining a rotation axis that is parallel to the plane of the support surface, and perpendicular to the respective swivel axis and radially spaced away from the swivel axis, preferably on the radially outermost edges of the rotatable swivel frame discs.

Accordingly, there are at least three turning arms in the mechanism for movably supporting the chassis on which the user rests his or her wrist. Each turning arm comprises a swivel assembly with a swivel frame that is mounted to rotate relative to the carriage on the swivel axis. This permits the turning arm to rotate so as to align the roller axle for any new rolling direction.

The swivel frames might happen to be at any random rotational orientation relative to their swivel axes. If a force then is applied by the wrist to move the carriage in a direction parallel to the plane of the desktop, the swivel frames rotate independently on their swivel axes to bring all the rollers into alignment to roll in that movement direction. More particularly, one or more of the rollers initially may be misaligned to the movement direction. The force applied in a direction of movement produces friction between the roller and the desktop. The eccentric placement of the roller on the swivel frame disc, at a radial distance from the swivel axis, translates the force into torque that turns the swivel frame on the swivel axis, moving the roller toward a position behind the swivel axis in the direction of movement. When the roller is directly behind the swivel axis, friction is at a minimum. The carriage moves smoothly.

Alignment of the swivel frames in this manner is independent for each of the supports. Thus, the force exerted by the wrist may be translation of the carriage across the desktop or rotation of the carriage on the desktop or any combination. The swivel frames comply with the direction of movement, rolling smoothly with minimal friction and substantially reduced sliding and wear.

Several embodiments of the invention are disclosed and have respective advantages. In each case, the swivel axis of the swivel frame relative to the carriage, the radius define by the swivel frame to the rolling axis of the eccentrically placed wheels or rollers, and said rolling axis of the wheels or rollers, define a series of right angles or “L” shapes wherein the swivel axis, the radial arm spacing over the swivel frame disk (parallel to the desktop) and the rolling axis of the roller are mutually orthogonal.

According to one embodiment, the specific mechanism of the rolling wheels comprises a pair of bearing frames at the end of an extended arm of a swivel frame, which occupy the radial spacing from the swivel axis to the roller and provide at their ends a pair of spring biased journal fittings for the ends of axles that carry the rollers.

According to another embodiment, at least three and preferably four spaced swiveling roller assemblies are provided for supporting the carriage. Each swivel frame is defined by a disc that fits in a circular depression on the underside of the wrist supporting carriage, for example at four corners of a carriage that has a rectangular or trapezoidal shape in plan view. The disc is flat on the underside and has an axially-upward extending hub that is received in a bushing or preferably a ball bearing race, set in the carriage at the center of the circular depression, defining a swivel axis for that swivel frame, normal to the plane of the desktop surface.

In one embodiment, the disc has a large diameter in relation to the diameter of the roller that is provided at a radial distance from the swivel axis, preferably at the extreme outer edge of the disc. In a version wherein the disc comprises thermoplastic material, the roller can be mounted in a radial slot extending inward from the edge of the disc, e.g., by heating and pressing an axle wire into the material of the disc.

The carriage can be a flat panel, approximately rectangular in plan view, carried above the desktop by only a few millimeters by which the rollers protrude from the surface of swivel frame discs that are flush with the underside of the carriage. The carriage panel can have an impression complementary to a human wrist, e.g., widening toward the mouse side. The carriage panel can be padded by a compressible material such as a foamed polyurethane or other soft plastic.

The invention has the beneficial characteristic that the swivel frame can define an extended lever arm from the rotation axis of the swivel frame to the roller, in a series of right angles. This enables even minimal friction associated with slippage of the rollers when misaligned to the direction of motion to generate torque on the swivel frame. The swivel frames of rollers reorient independently such that the rollers move to behind their respective swivel frame axes in the direction of motion. Reorientation is accomplished using very little force when the user changes the direction of motion of the mouse, and the direction of the wrist support of the invention. The invention eliminates discomfort and/or fatigue from extended periods of mouse operation, and is a valuable aid to persons with carpal tunnel syndrome or other arm disabilities who need to control a computer mouse.

### BRIEF DESCRIPTION OF THE DRAWINGS

There are shown in the drawings certain exemplary embodiments of the invention as presently preferred. However the invention is not limited to the embodiments disclosed as examples. In the drawings,

FIG. 1 is a partial perspective view showing the relationship of the gliding wrist and forearm support for mouse users to a computer user's station and mouse when in use;

FIG. 2 is a perspective view of the underside of the wrist support device according to a first embodiment;

FIG. 3 is an exploded perspective view showing the details of one of the four swivel arm structures shown in FIG. 1;

FIG. 4 is a partial plan view showing an assembled swivel arm structure;

FIG. 5 is a section view taken along line 5-5 in FIG. 4;

FIG. 6 is a section view taken along line 6-6 in FIG. 4;

FIG. 7 is a perspective view of the underside of a wrist support device according to another embodiment; and,

FIG. 8 is a partial exploded view showing the detail of the swivel arm structure in the embodiment of FIG. 7.

### DETAILED DESCRIPTION OF PREFERRED EMBODIMENTS

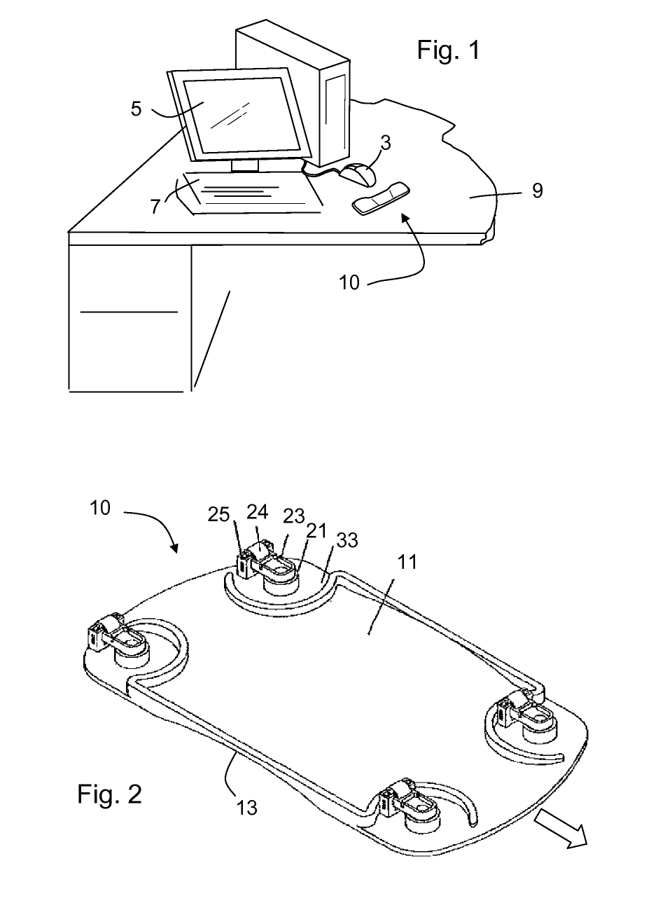

An exemplary user station for operating a personal or business computer is shown in FIG. 1. Among other aspects, the system comprises a pointing device, namely computer mouse 3, which is generally used to manipulate the position of a cursor on a display screen 5. In the embodiment shown, the mouse 3 is associated with a keyboard 7 and resides on a desktop 9. In other arrangements that are not shown, the keyboard and mouse could be placed on a shelf under the desktop or on one or more auxiliary support panels. The mouse could be used atop a mouse pad.

According to the invention, a wrist support device 10 is provided for use with the mouse 3. The wrist support device is configured to reside under the wrist of a human user, leaving the palm and fingers free to hold and manipulate mouse 3. In known manner, the user may wish to translate mouse 3 forward and rearward or side to side or diagonally. Insofar as the user's wrist remains on the wrist support device 10, manipulation of the mouse in this way also changes the direction of movement and orientation of the wrist support device. Movement of the wrist support device does not exactly mirror movement of the mouse because many users move the mouse relative to their wrist for fine positioning movements. Nevertheless, the user may wish to translate and to turn the mouse and in so doing to translate and to turn the wrist support. This is accomplished by moving the wrist support over the surface of the desktop 9.

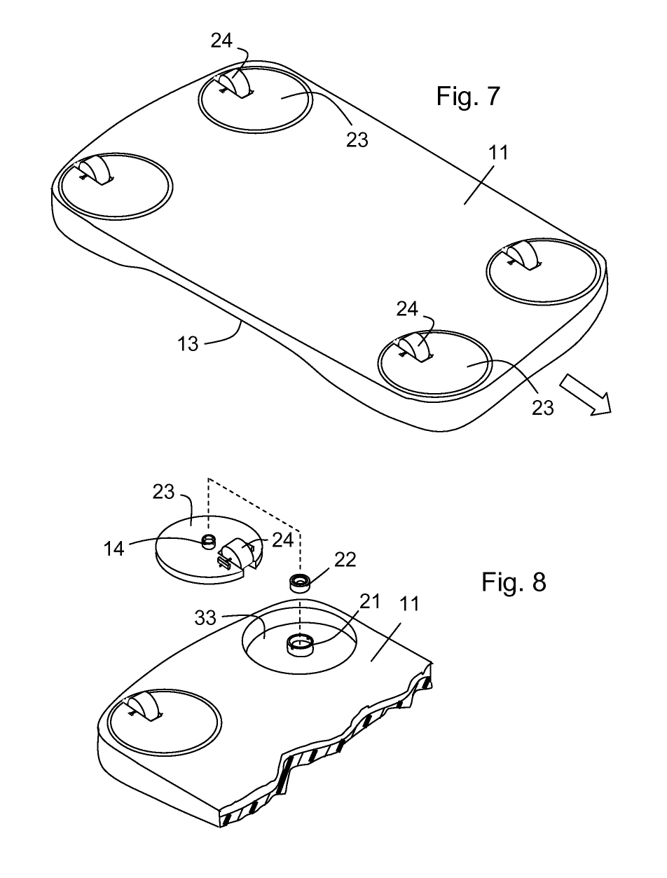

FIGS. 2 through 6 show one exemplary embodiment for the wrist support device 10, another embodiment being shown in FIGS. 7 and 8. In each of the embodiments, the inventive wrist support comprises a chassis 11 carried on a supporting mechanism mounted on the underside of the chassis 11, characterized by individually positioned roller mountings arranged to accommodate movement of the chassis 11 in any direction. As shown in FIG. 2, if a force is exerted to move the chassis in the direction of the block arrow, for example, the swivel arm assemblies that carry the rollers 24 rotate around an axis defined by a hub structure to position each roller 24 behind the swivel axis in the direction of motion. Each swivel assembly is independent, and if the chassis 11 should be turned, the swivel assemblies likewise accommodate the direction of movement locally.

The chassis 11 can comprise a molded plastic panel that can optionally be covered with a padded layer. The chassis 11 is supported by at least three swivel arm assemblies that are distributed under and around a central area at which the user's wrist shall rest, which area can have a depression 13 extending across the chassis 11, substantially complementary to the shape of a human wrist. Four swivel arm assemblies 12 are shown in the two depicted embodiments, each being located at a corner of the chassis. It is also possible to provide an array with more or fewer swivel assemblies. At least three provides a stable three point support. An array of four spaced swivel arm assemblies is even more stable and is unlikely to tip. According to an aspect of the invention, the swivel arm assemblies have provisions to permit the rollers 24 to be resiliently displaced up and down relative to the chassis, which accommodates minor differences in elevation across the desktop or tolerance in the positions of the swivel arms 23 that carry the rollers 24.

Each swivel arm assembly comprises a hub 14 protruding perpendicular to the plane of the chassis and received in a journal for rotation about a swivel axis. Affixed to the hub 14 is a laterally projecting arm 23, the length of which defines a radius about the swivel axis. At a radial space from the swivel axis, the arm 23 carries a wheel or roller 24, which is rotatable on an axis parallel to the plane of the chassis 11 (and parallel to the desktop). The roller axis is perpendicular to the radius defined by arm 23 and thus is on a tangent to a circle around the swivel axis.

In the depicted examples, the hub 14 of the swivel arm assembly is rotatably fixed in a collar 21 that is integrally molded with the chassis 11. A bearing 21, such as a ball bearing race or a pair of relatively rotatable bushings, is press fitted into the collar 21 and resides between the collar and the hub 14 of the swivel arm. This arrangement constitutes a low friction swivel mount that permits the swivel arm to rotate freely. In addition, the radial distance from the swivel axis to the roller is substantial, e.g., several times the radius of the roller 24.

When the user exerts a force, such as a force in the direction of the block arrow in FIG. 2, any one of the swivel arms may happen to be aligned in some direction other than the direction shown in FIG. 2, such that the roller 24 does not roll freely due to friction with the desktop. The force on the roller is transferred to torque on the swivel arm 23, in a direction that brings the roller 24 into the position shown in FIG. 2, behind the swivel axis in the direction of movement. At this position the roller 24 is rolls freely in the direction of motion. The torque on the swivel arm is the product of the radius of the swivel arm and the force on the roller. A relatively long radius of the swivel arm as shown, e.g., two to four times the diameter of the roller, dependably places the rollers 24 at their free rolling alignments with relatively little force required of the user.

The swivel axis of the swivel mount (perpendicular to the plane of the desktop), the extension of the arm 23 and the rotation axis of the roller 24 near the end of the arm 23 are mutually orthogonal. The swivel axis is oriented normal to the plane of the desktop 9 (FIG. 1). The arm 23 extends radially from the swivel axis. The rotation axis of roller 24 is parallel to the desktop and perpendicular to a radius of the swivel axis along the extended arm 23. This places the roller axis on a tangent to a circle around the swivel axis.

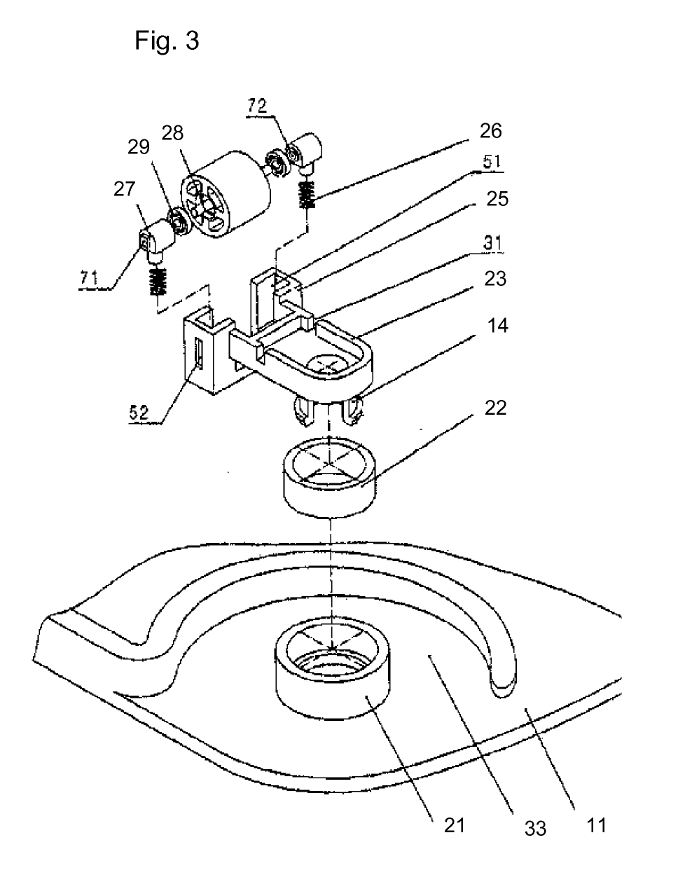

Each swivel arm 23 is mounted in a depression 33 on the underside of the chassis 11, via the low friction swivel mounting. A ball bearing race 22 is preferred between the arm 23 and the collar 21 that is molded integrally with the chassis 11 on the underside thereof. The hub 14 of the swivel arm can comprise a longitudinally slotted tube portion with a flanged end that snaps into engagement when set into the ball bearing. (See FIG. 3.) The ball bearing can be press fitted into the collar 21 on the chassis 11, which collar can also be slotted to permit some radial expansion during assembly.

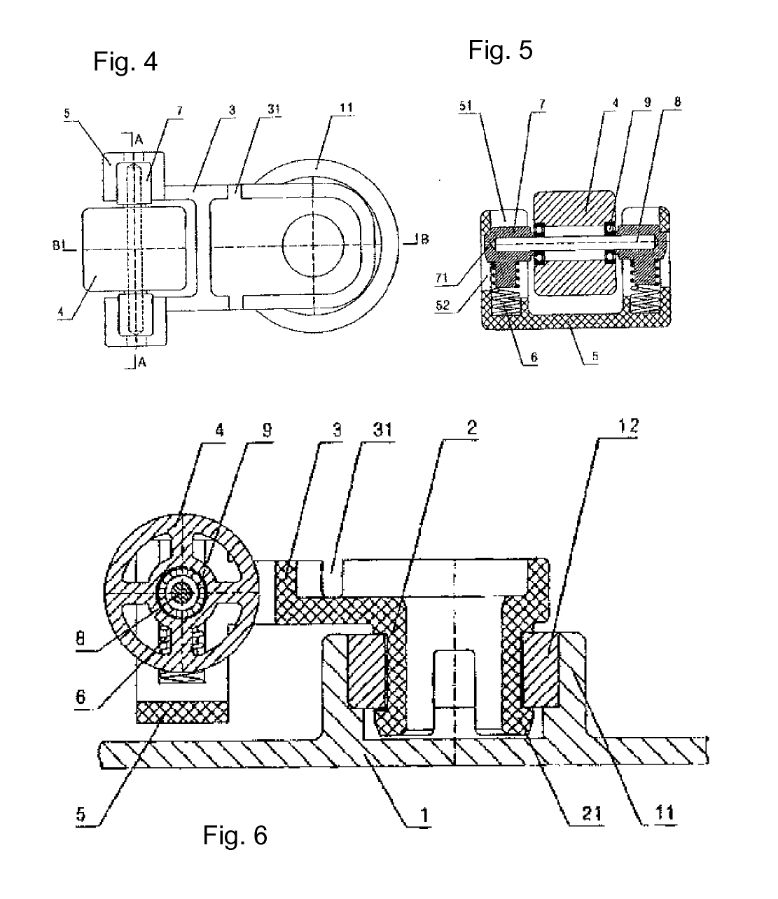

FIGS. 4-6 illustrate details of an embodiment wherein the rollers 24 are spring mounted in slotted frames 25 to permit vertical displacement of the rollers 24. For this purpose, the slotted frames 25 define fixed inwardly-opening channels or chambers 51 that have outward facing slots 52 providing a range of vertical movement for blocks 27. Blocks 27 receive the ends of the roller axle rod 28 and are biased by springs 26 to urge blocks 27 away from chassis 11. The ends of the axle rod 28 are press fitted into holes 72 in blocks 27. The blocks 27 have key parts 71 facing outwardly to engage in slots 52. The ends of slots 52 define the range of vertical motion of blocks 27, which in turn determines the extent of vertical displacement of rollers 24. The spring biased displacement of rollers 24 causes the rollers to stay in contact with the desktop over uneven areas. The rollers 24 can be carried on their axles 28 by additional ball bearings 29.

In addition to the vertical displacement of rollers 28 permitted by the spring mounting of the blocks 27 in channels 51, the swivel arm in this embodiment is arranged to bend under vertical pressure. FIGS. 3, 4 and 6 show a slot 31 in the structure of arm 23, where the arm is free to flex.

The swivel arm 23 and the slotted frames 25 both comprise flexible materials such as molded plastic or elastomer. The upper surface of the chassis 11 (namely the area in which the wrist is placed on the wrist mouse pad) is shaped with a depression or arc 13 in accordance with ergonomics. A compressible plastic pad can also be added to the surface of the chassis 11 (not shown in FIGS. 2-6 for additional comfort.

FIGS. 7 and 8 illustrate an alternative embodiment wherein a swivel arm and roller arrangement is provided using fewer parts than the embodiment off FIGS. 2-6. The same reference numbers are used in FIGS. 7 and 8 to identify comparable structures as compared to the embodiment of FIGS. 2-6.

In the embodiment of FIGS. 7 and 8, the swivel arm is provided by a disc shaped swivel arm structure 23. The hub 14 is centrally located on the disc and engages in bearing 22 and in collar 21 as in the previous embodiment. The disc shaped bearing arm 23 (shown upside-down in FIG. 8) fits into a depression 33 in the chassis 11.

The roller 24 is carried on a roller axle 28 that is set directly into the material of the swivel arm disc by a heated press operation that embeds the ends of roller axle 28 in the material of the disc, or more preferably, in low abutments 29 that are raised on the surface of the swivel arm disc 23 by the heated press operation. The roller axles (with the rollers thereon) are heated and pressed through the material of disc 23 from the side opposite from the hub 14. This displaces some material from the swivel arm disc 23, and the displaced material sets upon cooling in the shape of abutments 29, which reflect the shape of a depression in the heated press (not shown).

This arrangement locates the roller axle 28 near the level of the upper surface of the swivel arm disc 23. The roller 24 is thus mounted so that only a fraction of the diameter of the roller protrudes below the disc 23, thereby limiting the height of the chassis above the desktop in use. The disc 23 is somewhat resilient, such that downward pressure on the chassis from the user's wrist can deform the disc slightly, allowing the respective rollers to conform to irregularities in the desktop as in the previous embodiment.

In a preferred arrangement, the disc 23 is about one inch in diameter and the roller is about 0.25 inch in diameter. The roller protrudes downwardly from the surface of swivel arm disc 23 by about 2 mm.

As shown in FIG. 8 in partially cut-away section view, the chassis 11 in the embodiment of FIG. 8 is faced with a resilient material such as a compressible plastic foam or a foam rubber layer.

The wrist support of the invention is convenient and comfortable for the user. All that is necessary is place the chassis 11, roller side down, behind the mouse as shown in FIG. 1. In the case where the user has a mouse pad (not shown), the wrist support is placed next to the mouse pad on the desktop, so that the rollers 28 roll on the desktop. While operating the mouse, the user's wrist is disposed in its usual position. However instead of sliding the forearm over the desktop, the wrist support holds the wrist and forearm slightly above the desktop, while substantially reducing friction associated with sliding of the forearm on the desktop. With the mouse held by the palm and fingers, forces exerted by the arm in different directions (including turning or twisting the orientation of the wrist support) the wrist and the wrist support move together. The mouse is controlled with comfort and ease, eliminating fatigue and reducing stress on carpal tunnel or other disabilities.

The invention has been described with reference to preferred examples, but should not be regarded as limited to the examples. Reference should be made to the appended claims to assess the scope of the invention in which exclusive rights are claimed.

1. A wrist support for operating a pointing device on a surface, comprising:
a chassis configured to support a wrist;
a plurality of swivel assemblies coupled to the chassis, the swivel assemblies each comprising a swivel arm rotatably attached to the chassis at a swivel axis, and a roller carried on the swivel arm at a radial distance from the swivel axis;
wherein the roller is rotatably mounted on a roller axle defining a roller axis that is parallel to the surface and perpendicular to a radius of the swivel axis.

2. The wrist support of claim 1, wherein the swivel arm is rotatably attached to the chassis at the swivel axis by a collar formed in the chassis, a bearing fitted in the collar and a hub of the swivel arm fitted in the bearing.

3. The wrist support of claim 1, wherein the roller axle is resiliently fixed relative to the chassis for movement over a range perpendicular to the surface.

4. The wrist support of claim 3, wherein the swivel arm is resiliently flexible to define said range.

5. The wrist support of claim 3, wherein the swivel arm has a spring biased mounting for the roller axle.

6. The wrist support of claim 1, wherein the swivel arm comprises a disc received in a circular recess on an underside of the chassis.

7. The wrist support of claim 6, wherein the disc of the swivel arm is rotatably attached to the chassis at the swivel axis by a hub on one of the chassis and the disc rotatably fitted in a collar on the other of the chassis and the disc.

8. The wrist support of claim 7, wherein a central hub protrudes from the disc and is rotatably received in a collar in the recess on the underside of the chassis.

9. The wrist support of claim 7, further comprising a bearing disposed between the hub and the collar.

10. The wrist support of claim 9, wherein the bearing comprises relatively rotatable bushings respectively affixed to the swivel arm and to the chassis.

11. The wrist support of claim 10, wherein the bearing comprises a ball bearing race.

12. The wrist support of claim 6, wherein the roller is mounted at a radial slot at an outer edge of the disc.

13. The wrist support of claim 12, wherein the roller axle is embedded in the disc at least on one end of the roller axle.

14. The wrist support of claim 12, wherein the roller axle is affixed to the disc at a level of an upper surface of the disc.

15. The wrist support of claim 1, wherein the chassis defines a plane substantially parallel to the surface, wherein the plurality of swivel assemblies comprises at least three swivel arms distributed on the chassis, each of the swivel arms comprising a rotatable swivel connection to the chassis on an axis substantially perpendicular to the plane of the chassis, coupled by a swivel arm to a roller wheel having a rolling axis that is parallel to the plane of the chassis and perpendicular to both the swivel axis and a radius of the swivel axis defined by the swivel arm.

16. The wrist support of claim 15, comprising a pair of bearing frames at an end of the swivel arm opposite from the swivel axis, the bearing frames defining inwardly facing channels defining a range of movement of the rolling axis perpendicular to the plane of the chassis.

17. The wrist support of claim 16, wherein the roller axle is supported on opposite ends by blocks carried in the channels, and further comprising at least one spring mounted to bias the roller axles away from the plane of the chassis.

18. The wrist support of claim 17, further comprising slots in the channels and protrusions from the blocks received in the slots, wherein the slots are closed at least on an end opposite from the chassis, thereby limiting the range of movement of the rolling axis perpendicular to the plane of the chassis.
